(19) United States
(12) Patent Application Publication
(10) Pub. No.: US 2024/0003151 A1
(43) Pub. Date: Jan. 4, 2024

(54) SYSTEM AND METHOD FOR MANAGING A RETAIL STORE

(71) Applicant: Edip Yuksel, Cincinnati, OH (US)

(72) Inventor: Edip Yuksel, Cincinnati, OH (US)

(21) Appl. No.: 18/217,026

(22) Filed: Jun. 30, 2023

Related U.S. Application Data
(60) Provisional application No. 63/357,665, filed on Jul. 1, 2022.

(51) Int. Cl. E04H 3/02; G06Q 30/0601; G06Q 20/20

(52) U.S. Cl. CPC E04H 3/02; G06Q 30/0641; G06Q 20/202

(57) ABSTRACT

A building design for providing retail space that enhances the presentation and sale of a specific class of products. A decorative exterior structure resembling a typical item from the class of products is provided with a display floor accommodating multiple kiosks, each showcasing a variety of products within the class. The building may particularly be a jewelry store with a ring-shaped structure or a footwear store with a shoe-shaped structure. In the jewelry embodiment, the ring-shaped building incorporates set jewels and may include an outdoor patio conforming to the shape of the item and incorporate a camouflaged elevator shaft. The building design enables efficient product indexing, customer selection, automated movement for improved inspection, and optional magnification for jewelry items. The customer interface can be facilitated through a touchscreen, offering a seamless shopping experience.

### REFERENCE TO RELATED APPLICATION

This application claims benefit from currently pending U.S. Provisional Application No. 63/357,665 titled “System and Method for Managing a Retail Store” and having a filing date of Jul. 1, 2023, all of which is incorporated by reference herein.

### BACKGROUND OF THE INVENTION

### Field of the Invention

This invention relates to a unique commercial architecture, retail display, and point of sale experience. More specifically this invention relates to a themed retail space for providing retail services or to lease retail space to a plurality of vendors.

### Description of Related Art

Traditional retail showrooms are closing at an ever-increasing rate. Internet shopping is simple, convenient, and available for most products that consumers want to buy. Retailers face greater pressure to provide an environment that can draw foot traffic and shoppers to the showroom. Retailers group together in shopping malls to try to increase foot traffic for all the participating retailers and conventions or other gatherings can bring multiple retailers together to bring out consumers who are interested in a particular type of product. Such retail gatherings are expensive to administer and are limited in their effectiveness.

There remains a growing demand for a unique and immersive shopping experience that goes beyond traditional brick-and-mortar stores. Traditional jewelry retail stores often lack the ability to engage customers and provide a memorable experience. Customers are typically presented with limited choices and face challenges in visualizing how a piece of jewelry might look on them. Moreover, the process of finding the perfect jewelry item and receiving personalized assistance can be time-consuming and overwhelming. Consumers require a more immersive experience, ensuring a personalized and unforgettable shopping journey.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

Herndon, Nancy K. “The Power of Experiential Retail: Transforming Ordinary Shopping into Extraordinary Experiences” Palgrave Macmillan, 2018.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a method of providing retail space in which a class of products is sold. The shape of the building is essentially decorative to provide an event-like atmosphere. The building may be shaped to appear like an example of the class of products being sold or may appear to float above the ground. A method of providing retail space in which a class of products is sold is also provided to create an event-like atmosphere and effective shopping experience.

It is an object of the invention to provide an exterior design and interior layout that will be an attraction to shoppers.

It is another object of the invention to provide a retail space that is experienced as an event.

It is another object of the invention to provide an interactive display floor for multiple vendors of a single product class.

It is another object of the invention to provide an experiential and immersive retail space with interactive experiences for customers.

It is another object of the invention to provide vendors with a unique opportunity to reach out to customers and share costs with other vendors of the same product class.

It is another object of the invention to provide emerging brands and online retailers with a physical presence and create a sense of urgency and exclusivity for customers.

It is another object of the invention to provide a rotating concept where stores or kiosks change periodically keeping the shopping experience fresh and encouraging repeat visits.

It is another object of the invention to attract foot traffic and create a destination-like atmosphere.

The above and other objects may be achieved using devices involving a building to provide retail space in which a class of products is sold, the building comprising a decorative exterior structure shaped like a typical item in the class of products, a display floor in the building accommodating a plurality of kiosks, each kiosk displaying a plurality of products within the class of products. The class of products may be any class of products grouped by sellers for purchase by buyers. In particular embodiments the class of products is jewelry, footwear, printed publications, or restaurant. For example, if the class of products is jewelry, the structure may be shaped like a ring, bracelet, or necklace. As another example, when the class of products is footwear, the structure may be shaped like a shoe.

In a particular embodiment shown in the figures, the class of products is jewelry and the structure is shaped like a ring. The ring may particularly be styled as a single set jewel. The display floor of the building may be encompassed within the portion of the building that appears like the set jewel and may be elevated above ground level. An elevator is encompassed within a portion of the band of the ring. The building may also comprise an outdoor patio surrounding at least a portion of the display floor or at a separate level from the display floor. The design of the ring that the building resembles may incorporate the patio as a component of the ring.

The elevator may be housed in an elevator shaft that is viewable from outside the building as a separate columnar structure. The elevator structure may be essentially camouflaged from viewers at a distance by painting the elevator structure or having screens about the exterior of the elevator structure. Cameras may provide updated images or live video of the area surrounding the camouflaged structure and the curved screens may display the images or videos of the surrounding area effectively making the structure invisible to the naked eye from a distance. Camouflage may also be affected through paint or use of a material that is at least partially transparent.

The display floor of the building may have an entrance at one end and an exit at the opposite end and a checkout counter near the exit of the display floor to create a flow of customers. The number of kiosks may be adapted for the display floor, and in a preferred embodiment there are 19 kiosks. The kiosks on the display floor may be manned or unmanned, automatic, or digital. The kiosks may be indexed with a kiosk value and each of the plurality of products indexed with a product value such that a customer can refer to the kiosk value and the product value to identify a particular product.

In one or more embodiments the building has a base portion and a component portion, and the component portion has a decorative exterior structure and a display floor within the component portion. The surface of the base portion is configured to be essentially camouflaged to make it appear to viewers at a distance as if the decorative structure is floating above the air. The base portion may be painted or may be covered in one or more screens. A camera or series of cameras collect images of the space surrounding the base portion and the screens are adapted to display the space directly behind the base structure as if the base structure did not exist. A processor may process the images or video to create a desired image. Viewers at a distance would experience a view as if the base portion were not there and the decorative structure would appear to float above the ground.

The base portion may be substantially columnar, having a circular, ovoid, or polygonal cross section. The screens covering the surface of the base portion may be curved to accommodate a circular or ovoid shaped cross section or may be flat covering the polygonal cross section. The image displayed on the screens may be adjusted to disguise the appearance of the base portion more fully. The decorative exterior structure may be shaped like a class of products sold in the building. And the base portion may comprise an elevator configured to carry people to the component portion.

The above and other objects may be achieved using devices involving a building to provide retail space to a plurality of lessees that sell a class of products with a decorative exterior structure shaped like a typical item in the class of products. The decorative exterior has a plurality of facets, and each facet can have an indicator that can be selectively activated to highlight a particular facet of the building and thus also highlight a particular lessee in the building.

The indicator can be any combination of a light, a display screen, and a decoration. In a particular embodiment, the class of products is jewelry and the structure is shaped like a ring. The ring can have a large gem or set jewel feature and the facets may resemble the facets of the gem. The facet of the gem may have a sign or video display that identifies the sponsor or resident of that facet.

The owner of the building may seek to allow a retailer or brand to occupy space for a limited time. Emerging brands or online retailers may be given time to establish a physical presence and create a sense of urgency and exclusivity for customers. The facet of the building that is indicated may highlight a particular retailer or brand for a limited period of time and the interior kiosks of the building may be alternated between retailers to keep the shopping experience fresh and encourage repeat visits.

The interior display floor of the building may be shaped like the gem and encompassed within the portion of the building that appears like the gem. The display floor may be elevated, and an elevator placed within a portion of the band of the ring. The elevator shaft may be effectively camouflaged from viewers at a distance. An outdoor patio may surround at least a portion of the display floor.

A plurality of kiosks may be provided on the display floor, each kiosk being leased or assigned to one of the lessees of the building. The kiosks can have staff working at the kiosk or may be a digital kiosk. The staff working the kiosks may be employed by the lessee of the kiosk or may be employed by the owner of the building and provided by the building to the lessees. Online purchases may be picked up at lockers and the building may have a dock or bay area where vehicles may be parked for staff to deliver online purchases to customers. Customers may make purchases at a digital or manned kiosk and have their purchase wrapped or otherwise prepared and delivered to them in their vehicle at the dock.

The building may include at least one attraction, and the attraction can have a display that can be sponsored. Lessees may take turns sponsoring an attraction and the display can advertise or indicate the sponsor of the attraction.

The above and other objects may be achieved using methods involving providing retail space in which a class of products is sold by providing a building with a decorative exterior structure shaped like a typical item in the class of products and a display floor in the building accommodating a plurality of kiosks, each kiosk displaying a plurality of products within the class of products. Each of the plurality of kiosks may be automated and/or is indexed with a kiosk value and each of the plurality of products is indexed with a product value such that a customer can refer to the kiosk value and the product value to identify a particular product. The customer may be allowed to select a particular product through a customer interface. The product is automatically moved into a viewing space to allow improved inspection of the selected product by the customer.

When the class of products is jewelry, the automatic kiosk elevates and lights the piece (a selected ring, bracelet, necklace, etc.) to allow improved inspection. For example, each piece may be placed on a polygonal cutout that is elevated by a small motor in the base of the kiosk. The piece may be elevated into an already lighted area or additional lighting may be activated to better illuminate the piece. A magnifier may be provided and the kiosk may move the piece into the viewing field of the magnifier to allow closer inspection of the piece.

The customer may identify a particular product by the indexing values and an item substantially identical to the selected item may be pulled from inventory or the product may be retrieved either automatically or by a member of staff and taken to a point of sale where the customer may purchase the product. The customer may interact with a touchscreen or an augmented reality field to select a product in the kiosk. Sales staff may be made available on the periphery of the display floor for questions, help with operating the kiosks or performing sales for the products.

The above and other objects may be achieved using methods involving providing a building as described above and leasing each kiosk to a retailer to display the retailer's products in the class of products that the building is designed to reflect. The owner or a single lessee may use all of the kiosks for their own products or they may lease or sublease individual kiosks to additional merchants. The owner may provide staff to manage the display floor or process sales of products for the retailers. The lessees that have been leased a kiosk may each be associated with a facet of the building and different facets may be highlighted at different times. The facet associated with the scheduled lessee can be highlighted to provide extra buzz and publicity for a lessee. The highlighting can be done by using a video display to show promotional materials of a lessee, lights spelling out the name of a lessee, displaying a name or logo of a lessee, or using some other indicator to highlight the lessee. The interior kiosk of a lessee may be highlighted at the same time as when the facet associated with the lessee is highlighted.

The signs or displays around an attraction may also be rotated among the lessees of the building. A rotating schedule for each lessee to sponsor one or more attractions may be provided and the lessee may occupy the kiosk closest to the attraction at the scheduled time.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an isometric view of a building for retail space in accordance to one, or more embodiments;

FIG. 2 depicts a front view of a building for a retail space in accordance to one, or more embodiments;

FIG. 3 depicts a front view of a building for a retail space that appears to be partially submerged in accordance to one, or more embodiments;

FIG. 4 depicts a top view of a building for a retail space in accordance to one, or more embodiments;

FIG. 5 depicts a partially exploded isometric view of a building for a retail space in accordance to one, or more embodiments;

FIG. 6 depicts a partially exploded isometric view of a building for a retail space that appears to be partially below the ground in accordance to one, or more embodiments;

FIG. 7 depicts a top view of a building for a retail space in accordance to one, or more embodiments;

FIG. 8 depicts an isometric view of a building with a camouflaged shaft for a retail space in accordance to one, or more embodiments;

FIG. 9 depicts a top schematic view of a building for a retail space in accordance to one, or more embodiments;

FIG. 10 depicts a closeup isometric view of a building for a retail space in accordance to one, or more embodiments; and

FIG. 11 depicts a front view of a building for a retail space in accordance to one, or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. When a feature is described to apply to or for a lessee, it should be understood to apply to the owner of the building, a single lessee, or a plurality of lessees. The full scope of the inventions is not limited to the examples that are described below.

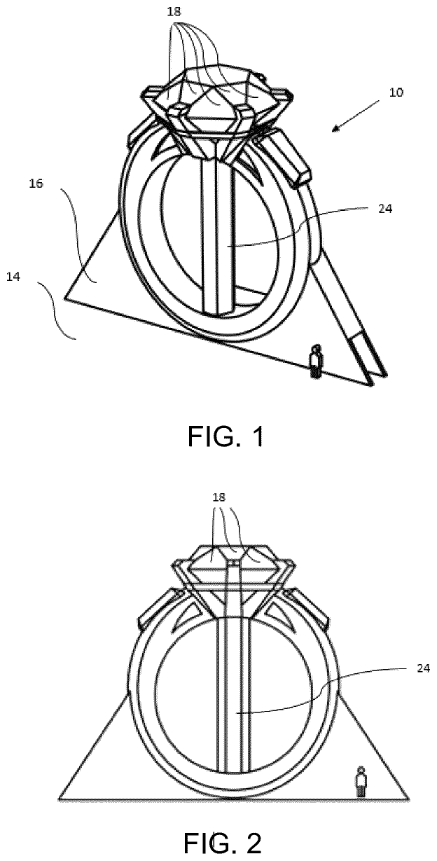

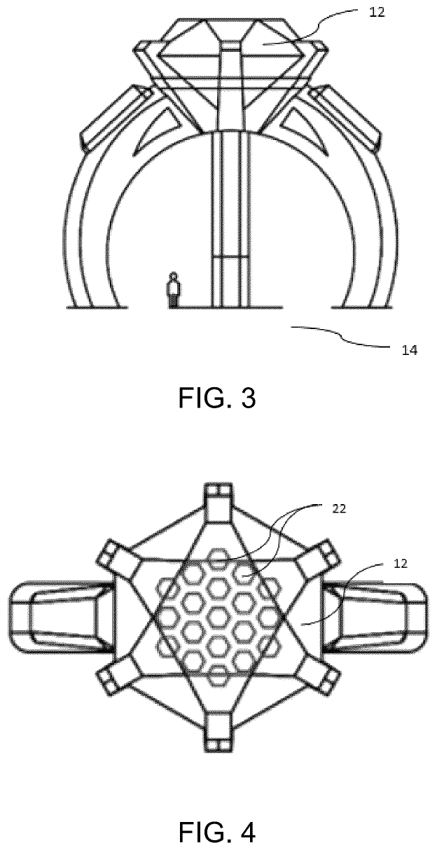

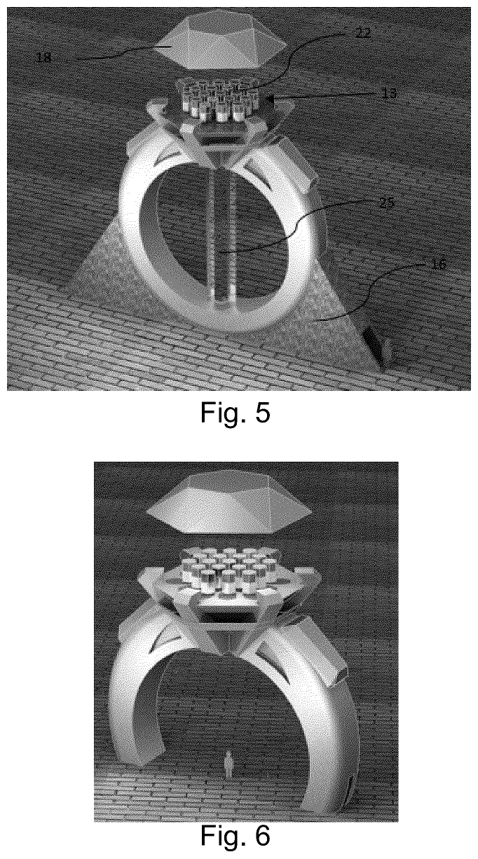

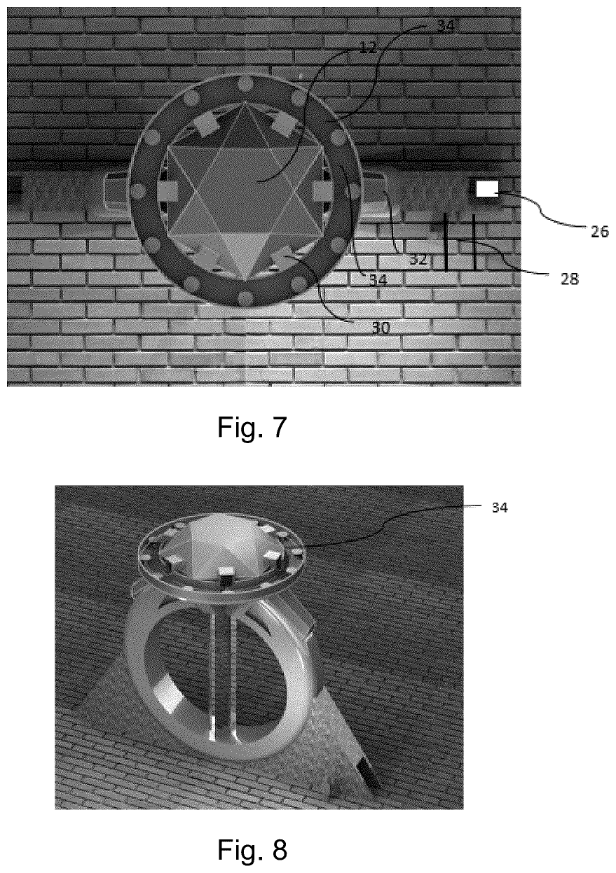

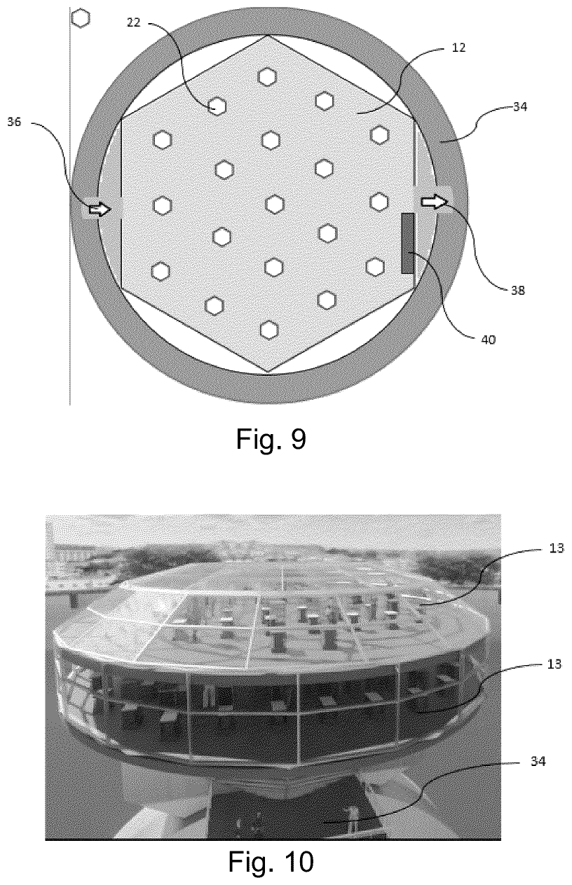

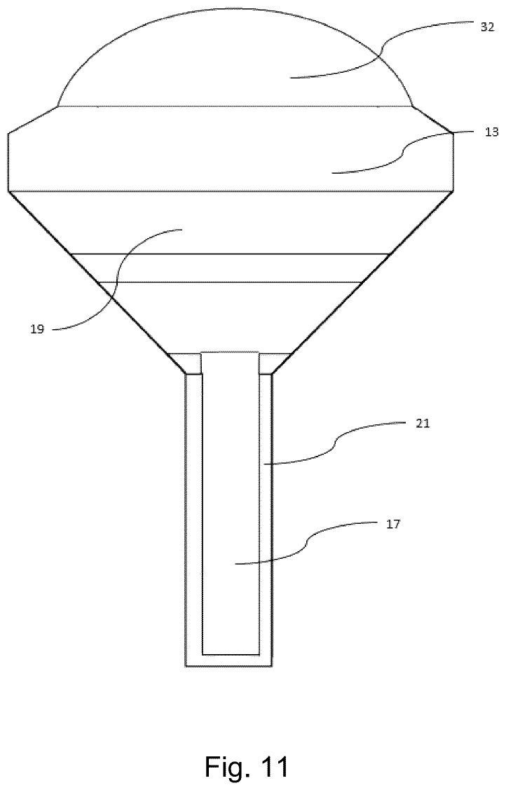

In one application of the invention, referring to FIGS. 1-11, a building 10 to provide retail space 12 in which a class of products is sold. The building has a decorative exterior structure 15 shaped like a typical item in the class of products, a display floor 13 in the building 10 accommodating a plurality of kiosks 22, each kiosk displaying a plurality of products within the class of products. The class of products may be any class of products grouped by sellers for purchase by buyers. In particular embodiments the class of products is jewelry or footwear. For example, if the class of products is jewelry, the structure 15 may be shaped like a ring, bracelet, or necklace. As another example, when the class of products is footwear, the structure 15 may be shaped like a shoe.

In a particular embodiment shown in the figures, the class of products is jewelry and the structure is shaped like a ring. The ring may particularly be styled as a single set jewel. The display floor 13 of the building may be encompassed within the portion of the building that appears like the set jewel and may be elevated above ground level. An elevator 24 is encompassed within a portion of the band of the ring. The building may also comprise an outdoor patio 34 surrounding at least a portion of the display floor 13, where the design of the ring incorporates the patio 34 as a component of the ring.

The elevator 24 may be housed in an elevator shaft 25 that is viewable from outside the building as a separate columnar structure. The elevator structure may be essentially camouflaged from viewers at a distance by painting the elevator structure or having screens about the exterior of the elevator structure. The screens may be displaying the view behind them captured by cameras or other sensors.

The display floor 13 of the building 10 may have an entrance 36 at one end and an exit 38 at the opposite end and a checkout counter 40 near the exit of the display floor 13 to create a flow of customers. The kiosks 22 on the display floor 13 may be manned or unmanned, automatic, or digital. The kiosks 22 may be indexed with a kiosk value and each of the plurality of products indexed with a product value such that a customer can refer to the kiosk value and the product value to identify a particular product. As shown in FIG. 10, the building may have multiple display floors 13 on different levels. Alternatively, the upper level may have an upper gallery 32, which may be used to display items in the same or different categories such as art work, silk rugs, antiques, or gems for the purposes of exhibition, sale, or auction. The upper gallery 32 may also be used for events such as social gatherings, lectures, or workshops.

In one or more embodiments the building 10 has a base portion 17 and a component portion 19, and the component portion 19 has a decorative exterior structure 15 and a display floor 13 within the component portion 19. The surface 21 of the base portion 17 is configured to be essentially camouflaged to make it appear to viewers at a distance as if the decorative structure 15 is floating above the air. The base portion 17 may be painted or may be covered in one or more screens. A camera or series of cameras collect images of the space surrounding the base portion and the screens are adapted to display the space directly behind the base structure as if the base structure did not exist. Viewers at a distance would experience a view as if the base portion were not there and the decorative structure would appear to float above the ground.

The base portion 17 may be substantially columnar, having a circular, ovoid, or polygonal cross section. The screens covering the surface 21 of the base portion 17 may be curved to accommodate a circular or ovoid shaped cross section or may be flat covering the polygonal cross section. The image displayed on the screens may be adjusted to more fully disguise the appearance of the base portion. The decorative exterior structure 15 may be shaped like a class of products sold in the building. And the base portion 17 may comprise an elevator 24 configured to carry people to the component portion.

In other embodiments, a building 10 is provided that can provide retail space 12 to the owner, single lessee, or a plurality of lessees that sell a class of products with a decorative exterior structure shaped like a typical item in the class of products. For example, for jewelry, the building 10 may be shaped like a ring—in particular, a ring singlet with a large set jewel as shown in FIG. 1-10. The ring may appear to be embedded in the ground 14 or may be supported by a support structure 16 that compliments the decorative structure of the building. The support structure 16 may be implemented into the building 10 such that the support structure 16 may also be occupied or otherwise used in connection with the building 10. The decorative exterior has a plurality of facets 18, and each facet 18 can have an indicator 20 that can be selectively activated to highlight a particular facet 18 of the building 10 and thus also highlight a particular lessee in the building 10. The indicator 20 can be any combination of a light, a display screen, and a decoration.

In a particular embodiment, the class of products is jewelry and the structure is shaped like a ring. The ring can have a large gem or set jewel feature and the facets 18 may resemble the facets of the gem. The facet of the gem may have a sign or video display that identifies the sponsor or resident of that facet.

The owner of the building may seek to allow a retailer or brand to occupy space for a limited time. Emerging brands or online retailers may be given time to establish a physical presence and create a sense of urgency and exclusivity for customers. The facet 18 of the building that is indicated may highlight a particular retailer or brand for a limited period and the interior kiosks 22 of the building may be alternated between retailers to keep the shopping experience fresh and encourage repeat visits.

The interior display floor 13 of the building 10 may have a shape similar to the shape of the gem and encompassed within the portion of the building 10 that appears like the gem. The display floor 13 is where the products may be displayed or offered for sale to customers, and may be housed within the ring jewel at a level elevated above ground level. The building 10 may include an elevator 24 accommodated within the ring portion of the building to bring shoppers from the ground level to the display floor 13. Alternatively, the elevator 24 may be camouflaged such that it cannot be seen from a distance. The elevator shaft 25 may be lined by screens and a camera may be used such that the screens lining the elevator shaft 25 display the area directly behind the screen. The exotic nature of the building shape and the disguised elevator may serve to attract consumers to the building to shop.

A plurality of kiosks 22 may be provided on the display floor 13, each kiosk 22 being leased or assigned to one of the lessees of the building. Kiosks 22 may have features to create more immersive interactive experiences for customers, including incorporating virtual reality (VR) and augmented reality (AR) technologies to provide virtual try-on experiences, interactive displays, and gamification elements to engage shoppers. The kiosks 22 can have staff working the kiosk or may be a digital kiosk. The staff working the kiosks 22 may be employed by the lessee of the kiosk 22 or may be employed by owner of the building 10 and provided by the building to the lessees. The employees may answer customer questions, manage and maintain the space, act as cashiers to process sales of products or perform other common retail tasks. Online purchases may be picked up at lockers 26 and the building may have a dock 28 or bay area where vehicles may be parked for staff to deliver online purchases to customers. Customers may make purchases at a digital or manned kiosk 22 and have their purchase wrapped or otherwise prepared and delivered to them in their vehicle at the dock 28.

The ring shape may include an observatory space 30 within the ring that is not part of the display floor 13. An upper gallery 32 may be provided below the display floor 13 and may be used for exhibitions of arts, presentations, conferences, or entertainment. The upper gallery 32 may be accessed from the elevator 24 or from the display floor 13 or the lower observatory space 30. The building 10 may also include an outdoor patio 34 ringing at least a portion of the display floor 13. The outdoor patio 34 may include benches or tables for shoppers to sit and enjoy the view from the raised patio 34.

To attract foot traffic and create a destination-like atmosphere, entertainment and leisure experiences may be incorporated including integration of movie theaters, indoor amusement parks, virtual reality arcades, interactive art installations, and experiential dining options within the building. The building may include at least one attraction, and the attraction can have a display that can be sponsored. Lessees may take turns sponsoring an attraction and the display can advertise or indicate the sponsor of the attraction. Appropriate attractions may include, a fashion runway, interactive product demonstrations, art installations, live performance spaces, guest speaker events, product launch parties, interactive gaming zones, beauty and wellness stations, food and beverage experiences, seasonal and thematic events, or extreme activity experiences.

The above and other objects may be achieved using methods involving providing a building 10 as described above and leasing each kiosk 22 to a retailer to display the retailer's products in the class of products that the building is designed to reflect. The owner may provide staff to manage the display floor 13 or process sales of products for the retailers. The lessees that have been leased a kiosk may each be associated with a facet 18 of the building and different facets may be highlighted at different times. The facet associated with the scheduled lessee can be highlighted to provide extra buzz and publicity for a lessee. The highlighting can be done by using a video display to show promotional materials of a lessee, lights spelling out the name of a lessee, displaying a name or logo of a lessee, or using some other indicator to highlight the lessee. The interior kiosk 22 of a lessee may be highlighted at the same time as when the facet associated with the lessee is highlighted.

The signs or displays around an attraction may also be rotated among the lessees of the building. A rotating schedule for each lessee to sponsor one or more attractions may be provided and the lessee may occupy the kiosk closest to the attraction at the scheduled time.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventor(s) for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A building to provide retail space in which a class of products is exhibited or sold, the building comprising:
a decorative exterior structure shaped like a typical item in the class of products;
a display floor in the building accommodating a plurality of kiosks; each kiosk displaying a plurality of products within the class of products.

2. The building of claim 1 wherein the class of products is jewelry and the structure is shaped like a ring or wherein the class of products is footwear and structured is shaped like a shoe.

3. The building of claim 2, wherein the class of products is jewelry and the structure is shaped like a ring and wherein the ring comprises at least one set jewel.

4. The building of claim 3 wherein the display floor is encompassed within the portion of the building that appears like the set jewel.

5. The building of claim 3 wherein the display floor is elevated above ground level and an elevator, escalator, or set of stairs is encompassed within a portion of the band of the ring.

6. The building of claim 1 wherein the building further comprises an outdoor patio surrounding at least a portion of the display floor, wherein the patio is shaped to conform to the shape of the typical item in the class of products.

7. The building of claim 1 wherein the display floor is elevated above ground level and the building comprises an elevator shaft that is effectively camouflaged from viewers at a distance.

8. The building of claim 1 further comprising an entrance at one end of the display floor, an exit at the opposite end of the display floor, and a checkout counter near the exit of the display floor.

9. The building of claim 1 further comprising a dock for customers to pick up online purchases.

10. The building of claim 1 wherein at least one of the plurality of kiosks is a digital kiosk.

11. The building of claim 1 wherein each of the plurality of kiosks is indexed with a kiosk value and each of the plurality of products is indexed with a product value such that a customer can refer to the kiosk value and the product value to identify a particular product.

12. A building to provide retail space, the building comprising:
a base portion and a component portion, wherein the component portion has a decorative exterior structure;
a display floor in the component portion;
wherein the surface of the base portion comprises one or more screens configured to essentially camouflage the base from viewers at a distance such that the component portion appears to float above the ground.

13. The building of claim 12 wherein the base portion is substantially columnar, having a circular, ovoid, or polygonal cross section.

14. The building of claim 12 wherein the decorative exterior structure is shaped like a class of products sold in the building.

15. The building of claim 12 wherein the base portion comprises an elevator configured to carry people to the component portion.

16. A method of providing retail space in which a class of products is sold, the method comprising:
providing the building of claim 1, wherein each of the plurality of kiosks is automated;
indexing each of the plurality of kiosks with a kiosk value and each of the plurality of products with a product value such that a customer can refer to the kiosk value and the product value to identify a particular product;
allowing the customer to select a particular product through a customer interface; and
automatically moving the product to allow improved inspection of the product in the kiosk.

17. The method of claim 16, wherein the class of products is jewelry, and wherein the product is elevated and lighted to allow improved inspection.

18. The method of claim 16, wherein the class of products is jewelry, the method further comprising providing a magnifier that magnifies the image of a viewing field for the customer, wherein the product is automatically placed in the viewing field to allow improved inspection.

19. The method of claim 16 further comprising allowing the customer to identify a particular product and retrieving the identified product to a point of sale.

20. The method of claim 16 wherein the customer interface is a touchscreen.
